(19) United States
(12) Patent Application Publication
(10) Pub. No.: US 2026/0309069 A1
(43) Pub. Date: Oct. 8, 2026

(54) COOLER FAN MODULE OF A MOTOR VEHICLE

(71) Applicant: BROSE FAHRZEUGTEILE SE & CO. KOMMANDITGESELLSCHAFT, WÜRZBURG, Würzburg (DE)

(72) Inventors: Anand PATEL, Oldenbrug (DE); Bernd MAURER, Bad Zwischenahn (DE); David TRIVUNOVIC, Belgrade (RS)

(21) Appl. No.: 19/596,455

(22) PCT Filed: Dec. 9, 2024
(86) PCT No.: PCT/EP2024/085280

§ 371 Date: Jun. 12, 2026

(30) Foreign Application Priority Data
Dec. 13, 2023 (DE) 10 2023 212 643.5

(51) Int. Cl. F01P 5/06; B60K 11/04

(52) U.S. Cl. CPC F01P 5/06; B60K 11/04

(57) ABSTRACT

A cooler fan module, in particular of a motor vehicle, with a fan shroud having a fan wheel recess and with a cooler that is connected or can be secured to the fan shroud, wherein, in the region of joining interfaces between the cooler and the fan shroud, a cooler-side joining element and a latching element are provided in each case, and wherein the fan shroud has joining contours corresponding to the cooler-side joining elements and latching contours corresponding to the latching elements.

The invention relates to a cooler fan module, preferably driven electrically (by an electric motor) and in particular of a motor vehicle, with a fan shroud and with a cooler that is or can be secured to the fan shroud.

Modern combustion engines, in particular four-stroke engines in motor vehicles, are typically cooled with a coolant that is guided over the combustion engine of the motor vehicle. In this process, the coolant absorbs the heat energy generated by the combustion engine and carries it away. The heated coolant flows through a heat exchanger, also known as a cooler, which is attached on the front side of the motor vehicle. By means of the cooler, an airflow absorbs heat energy from the coolant and cools the coolant down before the cooled coolant flows back to the combustion engine, thus closing the coolant circuit.

In order to convey the air through the cooler, a cooler fan, also called a fan system or fan device, is provided in front (upstream) of the cooler or behind (downstream of) the cooler in the flow direction and typically comprises a fan wheel, usually driven by an electric motor, as the conveying element for the air. Such a fan wheel is rotatably arranged within a fan wheel recess in the form of a continuous opening in a fan shroud. The fan shroud is typically connected to the cooler and forms a cooler fan module with it.

Due to the manufacturing process or the interaction of the components to be connected in the cooler fan module, the tolerances of the fan shroud and/or of the cooler may be very large. This leads to problems during the assembly of the cooler fan module and can result in unwanted noise generated between the fan shroud and the cooler.

The invention is based on the object of specifying a suitable cooler fan module. In particular, a mechanical interface between the cooler and the fan shroud that is particularly suitable with regard to ease of assembly, tolerance compensation, and/or the lowest possible noise generated is to be specified.

This object is achieved according to the invention by the features of claim 1. Advantageous embodiments and developments are the subject matter of the dependent claims.

Information regarding the spatial directions in a coordinate system of a motor vehicle (vehicle coordinate system) with respect to the typical position or location of a cooler fan module or a cooler and a fan shroud of the motor vehicle to its vehicle body is specified below. The abscissa axis (X-axis) here is oriented along the vehicle longitudinal direction, the ordinate axis (Y-axis) along the vehicle transverse direction, and the applicate axis (Z-axis) along the vehicle height.

The cooler fan module is in particular intended and configured for installation in a motor vehicle, for example for mounting on a body part in the engine compartment. The cooler fan module comprises a cooler and a fan shroud that is secured thereto, in particular via mechanical joining interfaces or brackets, or can be connected to the cooler. The fan shroud suitably has at least one opening or recess (fan wheel recess) for a fan wheel, preferably driven by an electric motor.

In the region of the (mechanical) joining interfaces (also called brackets below) between the cooler and the fan shroud, joining elements and a suitably equal number of latching elements are provided, preferably on the cooler side. The fan shroud has joining contours corresponding to the cooler-side joining elements and latching contours corresponding to the latching elements.

In an advantageous embodiment, each latching element is a latching hook molded onto the cooler. The corresponding latching contour is preferably a shroud-side latching recess, into which the cooler-side latching element latches in the joining connection between the cooler and the fan shroud.

Additionally or alternatively, a number of spring elements is advantageously provided in the region of the joining interfaces between the cooler and the fan shroud. Preferably, each spring element is arranged in the region of one of the joining elements, for example between one of the joining elements, and the latching element assigned thereto. The spring elements, which are preferably molded onto the cooler, suitably rest with their free ends against the fan shroud under spring preload. In other words, the spring elements provided in the region of the brackets or the joining interfaces are used to hold the fan shroud and the cooler together while preventing relative movement. This prevents or at least reduces noise from the cooler fan module.

Preferably, the joining elements and the latching elements are provided on opposite sides of the cooler, in particular sides extending in the Z direction with respect to the vehicle coordinate system. The corresponding joining contours and latching contours are provided on opposite sides of the shroud, in particular sides extending in the Z direction with respect to the vehicle coordinate system.

According to an advantageous embodiment, one of the cooler-side joining elements is designed as a, in particular cylindrical, plug pin with a round, in particular circular, pin cross section. Suitably, one of the joining contours corresponding to the respective cooler-side joining element is designed as a round, in particular circular, plug-in opening.

Additionally or alternatively, one of the cooler-side joining elements is designed as a plug pin, in particular with a curved or trapezoidal pin cross section, and the corresponding joining contour is designed as a curved or trapezoidal plug-in opening. Particularly preferably provided are a round, in particular circular or cylindrical, plug pin and a plug pin curved or trapezoidal in cross section, preferably on the cooler, as well as corresponding joining contours, preferably on the fan shroud.

The cooler suitably comprises at least two, preferably four, joining elements and at least two, preferably four, latching elements, and at least two, preferably four, spring elements. It is particularly advantageously provided that the cooler comprises two mutually spaced joining elements and two respective latching elements assigned thereto, as well as two respective spring elements assigned thereto and to the corresponding joining elements, on opposite sides of the cooler, which extend in particular in the Z direction with respect to a vehicle coordinate system.

The cooler particularly preferably comprises four joining and latching elements, suitably including a respective spring element, as brackets designed for corresponding joining interfaces in the fan shroud. The lower left bracket advantageously comprises a round plug pin with a circular dome as a joining element and the spring element as well as the latching element for creating a snap function on the cooler, which latches into the corresponding interface-side contour of the fan shroud.

The upper left bracket advantageously comprises a plug pin with a curved, preferably trapezoidal, geometry as a spring element, and the spring element as well as the latching element for creating a snap function on the cooler, which latches into a corresponding bore as a joining contour of the fan shroud. Alternatively, the upper left bracket on the cooler may also be designed as a round joining element or one that is circular in cross section.

The upper and lower right brackets suitably comprise a plug pin with a rectangular geometry as a joining element, and the spring element as well as the latching element for creating a snap function on the cooler, which latches into a corresponding bore as a joining contour of the fan shroud.

The combination of round and curved or trapezoidal bracket in the form of the correspondingly designed plug pins as, preferably cooler-side, joining elements, allows the cooler to be rotated relative to the fan shroud or the fan shroud to be rotated relative to the cooler about the correspondingly round or circular joining element. The plug pin with its curved or trapezoidal geometry as a joining element and the corresponding joining contour, in particular in the fan shroud, make it possible to follow the rotational movement to the desired extent, which makes particularly effective tolerance compensation possible. The latching connections, in particular in conjunction with the spring elements, make a particularly easy-to-handle or reliable joining connection between the cooler and the fan shroud possible.

The advantages achieved with the invention are in particular that the joining interfaces formed by brackets in the form of joining elements, latching elements, or spring elements between a cooler and a fan shroud provide a cooler fan module in which even large (manufacturing) tolerances can be compensated and unwanted noise generation is excluded or at least significantly reduced.

An exemplary embodiment of the invention is explained in more detail below with reference to drawings. In the figures:

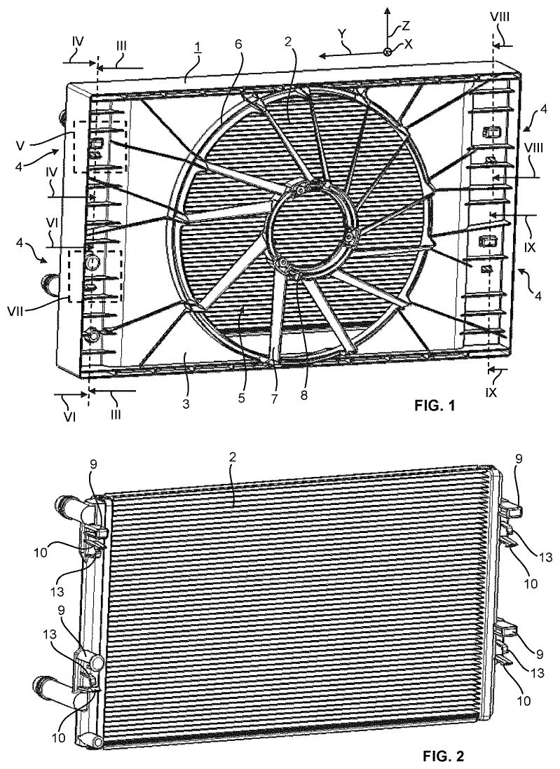

FIG. 1 is a perspective view of a cooler fan module with a cooler and with a fan shroud connected thereto at joining interfaces,

FIG. 2 is a perspective view of the cooler with a number of joining elements and latching elements as well as spring elements, in particular as brackets in the region of the joining interfaces,

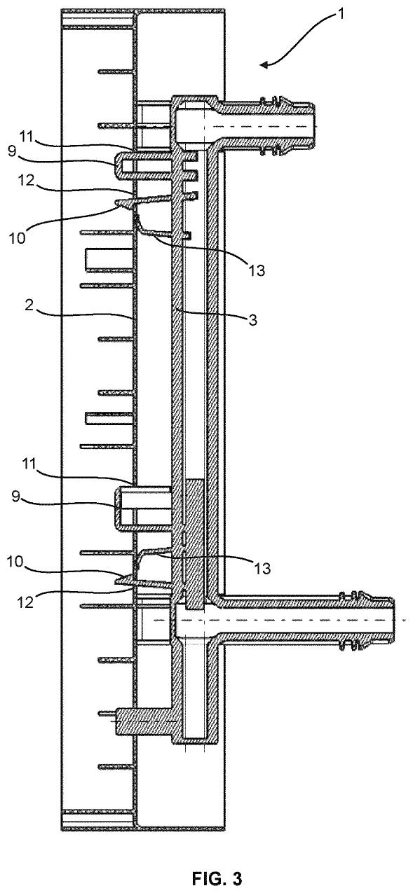

FIG. 3 is a sectional view along line III-III in FIG. 1, showing two different plug-in latching connections in the region of an upper and a lower left joining interface between the cooler and the fan shroud,

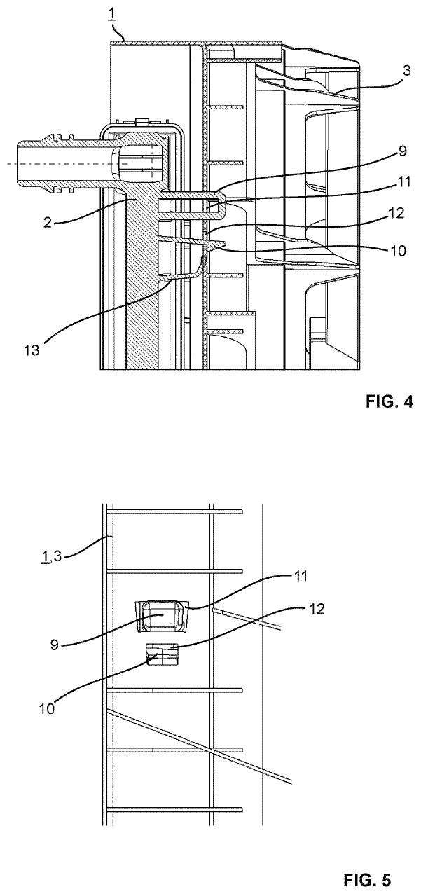

FIG. 4 is a sectional view along line IV-IV in FIG. 1, showing the joining connection in the region of the upper left joining interface between the cooler and the fan shroud,

FIG. 5 shows a detail V in FIG. 1 on a larger scale with a curved joining element of the cooler in a corresponding joining contour of the fan shroud,

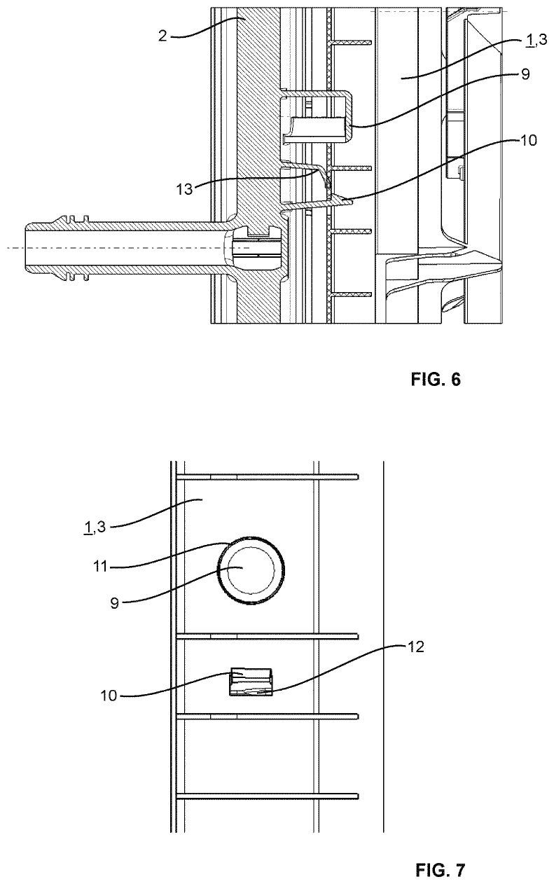

FIG. 6 is a sectional view along line VI-VI in FIG. 1, showing the joining connection in the region of the lower left joining interface between the cooler and the fan shroud,

FIG. 7 shows a detail VII in FIG. 1 on a larger scale with a round joining element of the cooler in a corresponding joining contour of the fan shroud,

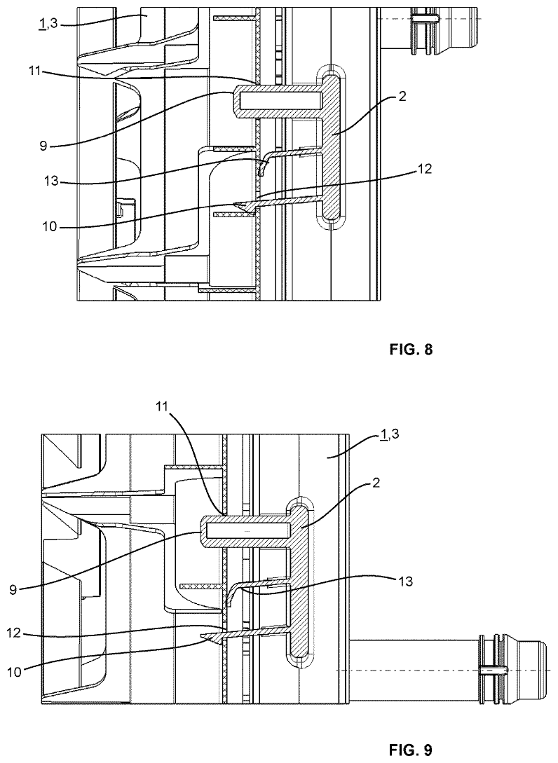

FIG. 8 is a sectional view along line VIII-VIII in FIG. 1, showing the joining connection in the region of the upper right joining interface between the cooler and the fan shroud, and

FIG. 9 is a sectional view along line IX-IX in FIG. 1, showing the joining connection in the region of the lower right joining interface between the cooler and the fan shroud.

Corresponding parts are provided with the same reference signs in all figures.

FIG. 1 shows a cooler fan module 1 with a cooler 2 and with a fan shroud 3 secured thereto. Its connection to the cooler 2 is made via mechanical joining interfaces 4, which are hereinafter also simply referred to as brackets. The fan shroud 3 has a recess (fan wheel recess) 5. This recess comprises an inner retaining ring 6, which is connected to an inner ring 8 via struts 7. The latter is intended or configured, in a manner not shown in detail, for mounting an electric motor that drives a fan wheel.

As can be seen in conjunction with FIG. 2 to 7, the brackets provided in the region of the joining interfaces 4 between the cooler 2 and the fan shroud 3 are formed from cooler-side joining elements 9 and latching elements 10. The fan shroud 3 has joining contours 11 in the form of plug-in openings corresponding to the cooler-side joining elements 9 and latching contours 12 corresponding to the latching elements 10. The latching elements 10 are latching hooks molded onto the cooler 2. The corresponding latching contours 12 are shroud-side latching recesses, into which the cooler-side latching element 10 latches in the joining connection between the cooler 2 and the fan shroud 3.

FIG. 2 shows the cooler 2 with the molded-on joining elements 9 and the likewise molded-on latching elements 10. In the exemplary embodiment, the joining elements 9 and the latching elements 10 are arranged on sides of the cooler that are opposite each other in the Y direction and extend in the Z direction with respect to the vehicle coordinate system shown in FIG. 1. The corresponding joining contours 11 and the latching contours 12 are arranged on sides of the fan shroud 3 that are opposite each other in the Y direction and extend in the Z direction.

In the exemplary embodiment, the joining elements 9, the latching elements 10, the corresponding joining contours 11, and the latching contours 12 are provided on the narrow sides of the rectangular cooler 2 and the likewise rectangular fan shroud 3. As can be seen, the joining elements 9 and the latching elements 10 are provided in the corner regions of the cooler 2, and the joining contours 11 and the latching contours 12 are provided in the corner regions of the fan shroud 3.

As can be seen in FIG. 3 to 7, in the region of the joining elements 9 and latching elements 10, the respective spring element 13 is provided at the joining interfaces 4 between the cooler 2 and the fan shroud 3. The spring element 13 is designed as a bent or curved tab, which is molded onto the cooler 2 and, in the joined state, rests with mechanical preload on the tab end side against the fan shroud 3 on the (inner) side facing the cooler 2.

As can be seen relatively clearly in FIG. 5, the cooler-side joining element 9 there is designed as a plug pin with a trapezoidal pin cross section. The corresponding joining contour 11 of the fan shroud 3 is designed as a curved or trapezoidal plug-in opening. The joining element 9 designed as a plug pin is inserted with play in the plug-in opening as a corresponding joining contour 11 of the fan shroud 3.

As can be seen relatively clearly in FIG. 7, the cooler-side joining element 9 there is designed as a round or cylindrical plug pin with a circular pin cross section. The joining contour 11 of the fan shroud 3 corresponding to this joining element 9 is designed as a round or circular plug-in opening.

According to FIGS. 8 and 9, the cooler-side joining elements 9 provided on the right side of the cooler fan module 1 in the exemplary embodiment are designed as rectangular plug pins and the corresponding shroud-side joining contours 11 are likewise designed as rectangular plug-in openings.

During assembly, the cooler 2 is placed onto the fan shroud 3 in the X direction. In this process, the cooler 2 can be rotated about the circular joining element 9. The contact between the cooler 2 and the fan shroud 3 is a line contact here. The rotational movement is made possible by the curved geometry of the upper left joining element 9 of the cooler 2 in the exemplary embodiment and the corresponding joining contour 11 of the fan shroud 3. The contact between the cooler 2 and the fan shroud 3 is a surface contact here.

The joining elements 9 on the right side of the cooler fan module 1 in the exemplary embodiment are mounted in the corresponding joining contours 11 of the fan shroud 3. The contact between the cooler 2 and the fan shroud 3 is a surface contact here. Existing tolerances of the brackets 4 from left to right are compensated by their snap function, in particular the or by means of the latching elements 10.

In the exemplary embodiment, four mechanical joining interfaces or brackets 4 are provided, namely two joining interfaces or brackets 4 each on the right and the left side of the cooler fan module 1. However, more than four mechanical joining interfaces or brackets 4 may also be provided, for example three mechanical joining interfaces or brackets 4 on the right side of a relatively large cooler fan module 1.

In summary, the invention relates to a cooler fan module 1 with a fan shroud 3 having a fan wheel recess 5 and with a cooler 2 that is connected or can be secured thereto, wherein, in the region of a joining interface 4 between the cooler 2 and the fan shroud 3, a cooler-side joining element 9 and a latching element 10 are provided in each case, and wherein the fan shroud 3 has joining contours 11 corresponding to the joining elements 9 and latching contours 12 corresponding to the latching elements 10.

The claimed invention is not restricted to the exemplary embodiments described above. Rather, other variants of the invention can also be derived therefrom by the person skilled in the art within the scope of the disclosed claims, without departing from the subject matter of the claimed invention, for example also the use in hybrid or electric vehicles. In particular, all individual features described in connection with the various exemplary embodiments can also be combined with one another in other ways within the scope of the disclosed claims, without departing from the subject matter of the claimed invention.

### LIST OF REFERENCE SIGNS

1 Cooler fan module
2 Cooler
3 Fan shroud
4 Bracket/joining interface
5 Fan wheel recess/recess
6 Retaining ring
7 Struts
8 Inner ring
9 Joining element
10 Latching element
11 Joining contour
12 Latching contour
13 Spring element

1. Cooler fan module, in particular of a motor vehicle, with a fan shroud and with a cooler that is connected or can be secured to the fan shroud,
wherein, in the region of a number of joining interfaces between the cooler and the fan shroud, a cooler-side joining element and a latching element are provided in each case, and
wherein the fan shroud has joining contours corresponding to the cooler-side joining elements and latching contours corresponding to the latching elements.

2. Cooler fan module according to claim 1,
wherein
a number of spring elements is provided in the region in the joining interface between the cooler and the fan shroud.

3. Cooler fan module according to claim 2,
herein
each spring element is arranged in the region of the respective joining element and the latching element assigned thereto, and/or
the spring elements are molded onto the cooler and at their free ends rest against the fan shroud under spring preload.

4. Cooler fan module according to claim 1,
wherein
the latching element is a latching hook molded onto the cooler, and the corresponding latching contour is a shroud-side latching recess or opening into which the cooler-side latching element latches in the joining connection between the cooler and the fan shroud.

5. Cooler fan module according to claim 1,
wherein
the cooler-side joining elements and latching elements are provided on sides of the cooler that are opposite each other and/or extend in the Z direction with respect to a vehicle coordinate system (X, Y, Z), and
the corresponding joining contours and latching contours are provided on sides of the shroud that are opposite each other and/or extend in the Z direction with respect to a vehicle coordinate system (X, Y, Z).

6. Cooler fan module according to claim 1,
wherein
one of the cooler-side joining elements is designed as a plug pin with a round, in particular circular, pin cross section.

7. Cooler fan module according to claim 1,
wherein
one of the joining contours corresponding to the respective cooler-side joining elements is designed as a round, in particular circular, plug-in opening.

8. Cooler fan module according to claim 1,
wherein
one of the cooler-side joining elements is designed as a plug pin with a curved, in particular trapezoidal, pin cross section and the corresponding joining contour is designed as a trapezoidal plug-in opening.

9. Cooler fan module according to claim 1,
wherein
the cooler comprises at least two, preferably four, joining elements and at least two, preferably four, latching elements and/or at least two, preferably four, spring elements.

10. Cooler fan module according to claim 1,
wherein
the cooler comprises two mutually spaced joining elements and two respective latching elements assigned thereto and/or spring elements assigned to the corresponding joining elements on sides of the cooler that are opposite each other, in particular extend in the Z direction with respect to a vehicle coordinate system (X, Y, Z).
